(19) United States
(12) Patent Application Publication
(10) Pub. No.: US 2013/0187619 A1
(43) Pub. Date: Jul. 25, 2013

(54) SHUNT REGULATOR

(71) Applicant: Richard A. Dunipace, Highland Village, TX (US)

(72) Inventor: Richard A. Dunipace, Highland Village, TX (US)

(73) Assignee: Fairchild Semiconductor Corporation, San Jose, CA (US)

(21) Appl. No.: 13/544,157

(22) Filed: Jul. 9, 2012

Related U.S. Application Data
(60) Provisional application No. 61/588,432, filed on Jan. 19, 2012.

(51) Int. Cl. G05F 1/613

(52) U.S. Cl. 323/225

(57) ABSTRACT

This document discusses, among other things, a circuit including a diode and a transistor. In certain examples, an integrated circuit can include the diode and the transistor. In some examples, an apparatus can include the diode having a first temperature coefficient, a bias resistor configured to bias the diode, and a bipolar junction transistor having a second temperature coefficient the bipolar junction transistor having a base coupled to the diode and the bias resistor, wherein the first temperature coefficient and the second temperature coefficient are configured to reduce at least a portion of a temperature drift effect of the diode and the bipolar transistor.

### CLAIM OF PRIORITY AND RELATED APPLICATIONS

This patent application claims the benefit of priority, under 35 U.S.C. Section 119(e), to Dunipace, U.S. Provisional Patent Application Ser. No. 61/588,432, entitled “HIGH EFFICIENCY, THERMALLY STABLE GROUND REFERENCED REGULATOR,” filed on Jan. 19, 2012 (Attorney Docket No. 2921.161PRV), which is hereby incorporated by reference herein in its entirety.

### BACKGROUND

Electric utilities have recently begun to monitor customer power usage using “smart” electrical meters. In addition to the overall amount of energy consumed at a location, the smart meters can monitor the quality of the energy and the particular time when the energy was used. The information can be used to more accurately bill a customer. In addition, the smart meters can transmit the energy information to a central location without the need for personnel to observe the meter. In certain examples, the smart meter may require 8 watts to transmit the energy information. When not transmitting, the smart meter may only use 0.25 watts of power. Typical power supply regulators can use 48 milliwatts (mW) or more of power. During non-transmission times, the regulator may use about 20% of the meter power. This is wasted energy. This wasted energy is characteristic of other devices that monitor conditions during standby, such as devices that can be used with a remote control. Significant energy savings can be realized with more efficient power supply regulators.

### OVERVIEW

This document discusses, among other things, a circuit including a diode and a transistor. In certain examples, the circuit can be an integrated circuit that can include the diode and the transistor. In some examples, a regulator can include the diode having a first temperature coefficient, a bias resistor configured to bias the diode, and a bipolar junction transistor having a second temperature coefficient, the bipolar junction transistor having a base coupled to the diode and the bias resistor, wherein the first temperature coefficient and the second temperature coefficient are configured to reduce at least a portion of a temperature drift effect of the diode and the bipolar transistor.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an existing adjustable zener shunt regulator

FIG. 2 illustrates generally an example high-efficiency, thermally stable ground-referenced shunt regulator.

FIG. 3 illustrates generally a partial schematic of a non-isolated output regulator for a switching power supply, such as can be used in a smart meter.

FIG. 4 illustrates an example low drop out regulator including a depletion mode output transistor.

FIG. 5 illustrates an example low drop out regulator that uses a red light emitting diode (LED) as part of the reference, and has a MOSFET output transistor.

FIG. 6 illustrates generally a high-power shunt regulator.

FIG. 7 illustrates generally an isolated output regulator for a switching power supply, such as can be used in a smart meter power supply.

FIG. 8 illustrates generally an example isolated power supply output current regulator with overvoltage protection.

FIG. 9 illustrates generally a partial power supply including a primary side regulator.

FIG. 10 illustrates generally an example temperature sensor that can also provide a stable reference voltage.

FIGS. 11 and 12 illustrate generally test circuits for providing analog voltage representative of temperature and a reference voltage.

FIG. 13 illustrates generally an example temperature sensor circuit.

FIG. 14 illustrates generally an example temperature control system.

FIG. 15 illustrates generally an oscillator circuit including an example temperature control system.

FIG. 16 illustrates generally an example temperature-stabilized, high-precision, voltage reference circuit.

FIG. 17 illustrates generally an example isolated power supply output current regulator with overvoltage protection.

FIG. 18A, 18B, and 18C illustrate generally circuits including example current sources.

FIG. 19 illustrates generally a buck type voltage converter including an example regulator.

### DETAILED DESCRIPTION

Power levels for smart meters can range between 1 watt (W) and 15 W. Non-smart meters can have power levels of around 1 W. In certain examples, smart meter specifications can allow continuous transmission of energy information so the power supplies need to be dimensioned for the high power levels used during transmission. In certain examples, a smart meter can use about 0.25 watts between transmissions for housekeeping (˜99% of the time). Power that is used by a secondary power supply regulator can significantly impact the overall efficiency of the power supply during housekeeping intervals. Traditional regulators can require 1 mA worst-case keep-alive current, plus 0.5 to 1 mA for the reference divider, plus any current needed for an optical isolator if the regulator is isolated. Overall, this can amount to 48 mW. In power supplies with low power outputs, such as 250 mW output, this can amount to ˜19.2% power loss.

The present inventor has recognized, among other things, example ground referenced, zener diode based regulators that can be thermally stable by matching a thermal coefficient of a regulator transistor to a complimentary thermal coefficient of a regulator diode. Such regulators can provide high quality, thermally stable, low-current references at low power and price. Example regulators can use only a few milliwatts, in certain examples, and are capable of significantly improving overall efficiency of power supplies used in low power applications.

In certain examples, a high-efficiency regulator can use less than 6.24 mW (at 250 mW output, ˜3% loss). If 10 million smart meters are installed using a high-efficiency regulator, the power savings can be around 500,000 watts compared to regulators based on a LM431 type adjustable precision zener.

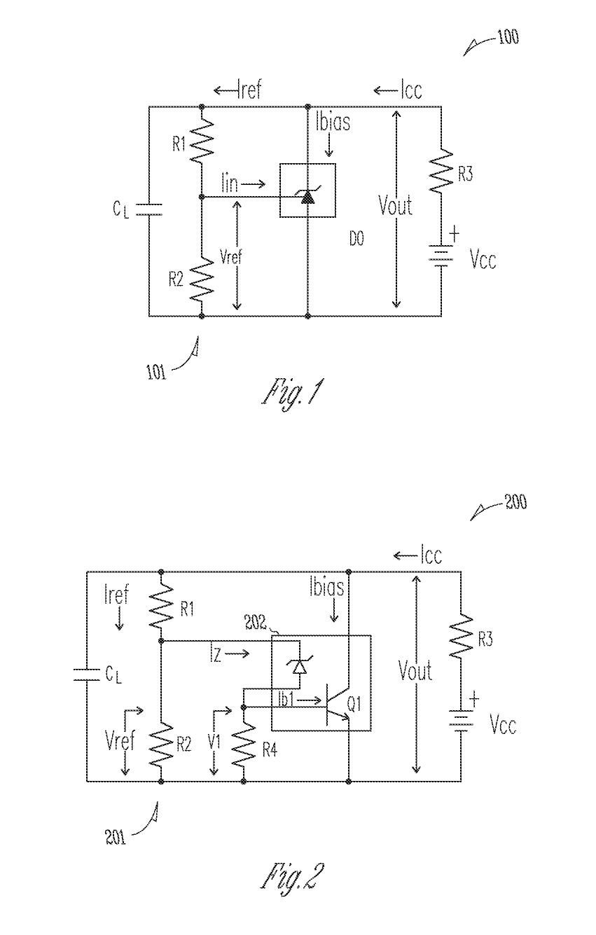

FIG. 1 illustrates an existing adjustable zener shunt regulator circuit 100. The adjustable zener shunt regulator circuit 100 can include a precision shunt regulator (D₀), such as a Fairchild Semiconductor LM431 adjustable shunt regulator, and a voltage divider 101 to provide a reference voltage (V_{REF}) to an input of the shunt regulator (D₀). The voltage divider 101 can include a first resistor (R₁) and a second resistor (R₂). The adjustable zener shunt regulator circuit 100 can be coupled to a supply voltage (V_{CC}) through a third resistor (R₃). An output voltage (V_{OUT}) of the circuit can be about:

V_{OUT}=V_{REF}(1+R₁/R₂). (Eq. 1)

Such circuits can typically provide a regulated voltage of between about 2.5 volts and about 37 volts. The minimum supply current is about 1 milliamp (mA) and the thermal stability is about 50 ppm/C.

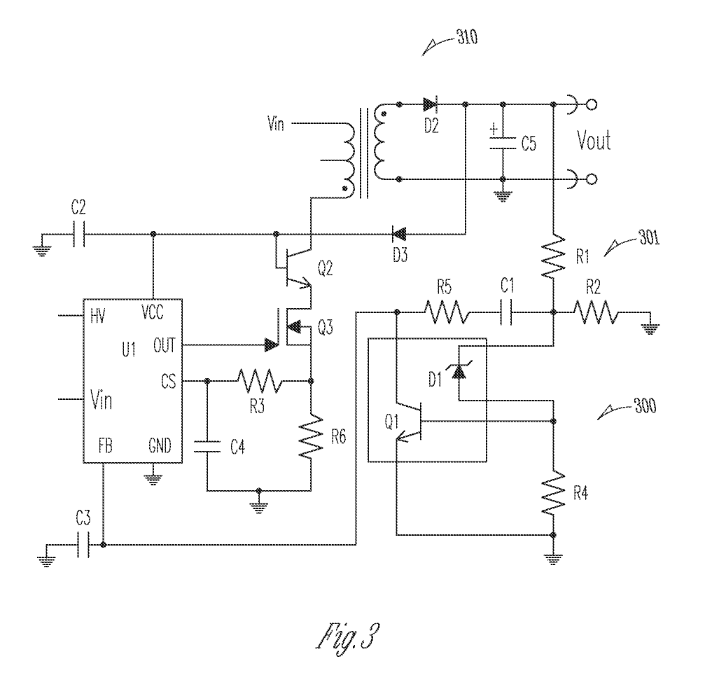

FIG. 2 illustrates generally an example high-efficiency, thermally stable ground-referenced regulator 200. The high-efficiency, thermally stable ground-referenced regulator 200 can include an integrated circuit 202 including a transistor, such as a bipolar transistor (Q1), and a diode (D1), such as a zener diode. The high-efficiency, thermally stable ground-referenced regulator 200 can also include a bias resistor (R4) and a voltage divider 201 including a first resistor (R1) and a second resistor (R2). The high-efficiency, thermally stable ground-referenced regulator 200 can be coupled to a supply voltage (V_{CC}) through a third resistor (R3) and can provide an adjustable output voltage (V_{OUT}). In certain examples, the minimum current of the high-efficiency, thermally stable ground-referenced regulator 200 can be less than about 10 microamps (μA) and the output voltage (V_{OUT}) can be configured between about ground and about 100 volts. The voltage across the diode (D1) and the voltage across the base emitter junction of the bipolar transistor (Q1) can provide a thermally stable voltage reference (V_{REF}). The bias resistor (R4) can set a bias current for diode (D1). In certain examples, the diode current can be set via the bias resistor (R4) to produce a thermal coefficient that closely matches and complements the emitter-base junction thermal coefficient of the bipolar transistor (Q1). In certain examples, the bias resistor (R4) can be used to provide a bias current to the diode (D1) such that the thermal stability of the high-efficiency, thermally stable ground-referenced regulator 200 is on the order of about −5.4 ppm/C. In certain examples, the first and second resistors (R1, R2) of the voltage divider can be adjusted to set the output voltage such that,

V_{OUT}=V_{REF}(1+R₁/R₂). Eq. 2

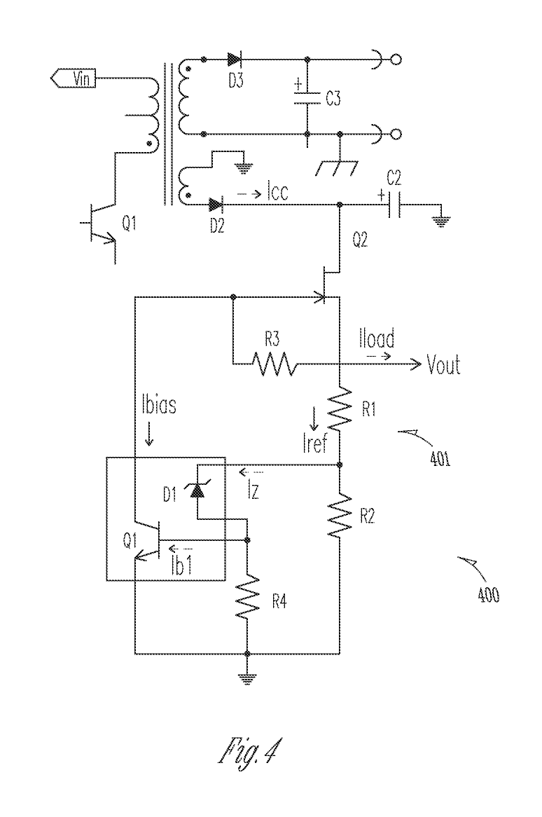

FIG. 3 illustrates generally a power supply 310 for a smart meter including an example regulator 300. The power supply 310 can include a controller (U1), a power transistor (Q3), a transformer (T1), and an example regulator 300. The controller (U1) can control the power transistor (Q3) to generate a voltage at the secondary of the transformer (T1). For example, when the controller (U1) provides a positive pulse to the gate of the power transistor (Q3), the transistor can turn on, and in turn, turn on a second power transistor (Q2). The voltage across the primary windings of the transformer (T1) can drop, thus inducing a voltage on the secondary winding of the transformer (T1). One or more diodes (D2) can rectify the voltage on the secondary of the transformer (T1) to provide an output voltage (V_{OUT}). The output voltage (V_{OUT}) and energy can be stored on a capacitor (C5). As the controller (U1) continues to drive the power transistor (Q3), the voltage on the capacitor (C5) can increase. At about a desired output voltage, a diode (D1) can couple the voltage to the base of a regulator transistor (Q1), turning on the regulator transistor (Q1) and lowering the voltage at a feedback pin (FB) of the controller (U1). In response to the lower voltage at the feedback pin (FB), the controller (U1) can reduce, for example, a pulse width of a pulse to the power transistor (Q3), thus controlling the output voltage (V_{OUT}) to a predetermined level established by the relationship of the resistors (R1, R2) of a voltage divider 301. A bias resistor (R4) can set a bias current of the diode (D1). In certain examples, the diode current can be set via a bias resistor (R4) to produce a thermal coefficient that closely matches and complements the emitter-base junction thermal coefficient of the regulator transistor (Q1).

In the illustrated example, the output voltage (V_{OUT}) can be about 12 volts, the operating current of the example regulator 300 can be about 210 μA, and the thermal stability of the example regulator 300 can be about −42.9 ppm/C. In certain examples, the first and second resistors (R1, R2) of the voltage divider 301 can be adjusted to set the output voltage according to Eq. 2.

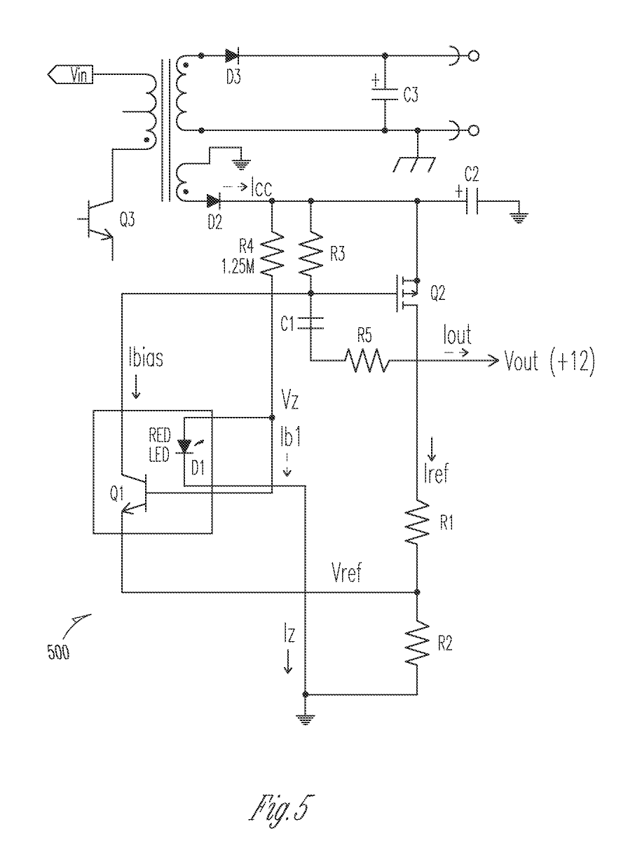

FIG. 4 illustrates an example low drop out (LDO) regulator 400 including a depletion mode control transistor (Q2), such as an n-channel JFET transistor. Without a voltage applied to the gate of the control transistor (Q2), the rectified supply voltage, such as that voltage across smoothing capacitor (C3), can be coupled to a regulator output to provide the output voltage (V_{OUT}). The output voltage (V_{OUT}) can establish a reference current (I_{REF}) through a voltage divider 401 including a first resistor (R1) and a second resistor (R2). The reference current (I_{REF}), in turn, can produce a voltage drop across the first and second resistors (R1, R2) and an error voltage at the common connection of the first and second resistors (R1, R2). The error voltage can be compared to a voltage reference (Vref) produced by the combination of the voltage across diode (D1) and the base-emitter voltage of a regulator transistor (Q1). If the error voltage exceeds the voltage reference (Vref), the conduction of the regulator transistor Q1 can increase. If the error voltage is less than the voltage reference (Vref), the conduction of the regulator transistor (Q1) can decrease. Thus, as the output voltage (V_{OUT}) increases above a desired voltage, a representation of the output voltage (V_{OUT}) can be coupled to the base of the regulator transistor (Q1) via the diode (D1) (e.g., a zener diode, etc.). As the output voltage (V_{OUT}) increases further, the regulator transistor (Q1) can turn on, thus biasing the control transistor (Q2) and increasing the impedance between the rectified supply voltage and the output to regulate the output voltage (V_{OUT}) about the desired voltage level. In an example, the output voltage (V_{OUT}) can be adjusted via the ratio of the first and second resistors (R1, R2) such that:

V_{OUT}=V_{REF}(1+R₁/R₂), Eq. 3

where the reference voltage (V_{REF}) can include the voltage across the diode (D1) and the voltage across the base-emitter junction of the regulator transistor (Q1). In an example, the reference current (I_{REF}) can be about 100 uA at the desired output voltage and the diode (D1) can have a current of about 10 uA (Iz), such that the reference voltage is about 7.275 volts. In such an example, the regulator bias current can be about 120 uA and the LDO regulator 400 can have a thermal stability of about −105 ppm/C. In certain examples, the depletion mode control transistor (Q2) can be replaced with a different type of transistor or combination of transistors including, but not limited to, a junction gate field-effect transistor (JFET), metal-oxide-semiconductor fieid-effect transistor (MOSFET), BJT, Darlington transistor, etc. In such examples, a control node (e.g., base node or gate node) of the depletion mode control transistor (Q2), or other type of transistor, can be coupled to the regulator transistor (Q1)

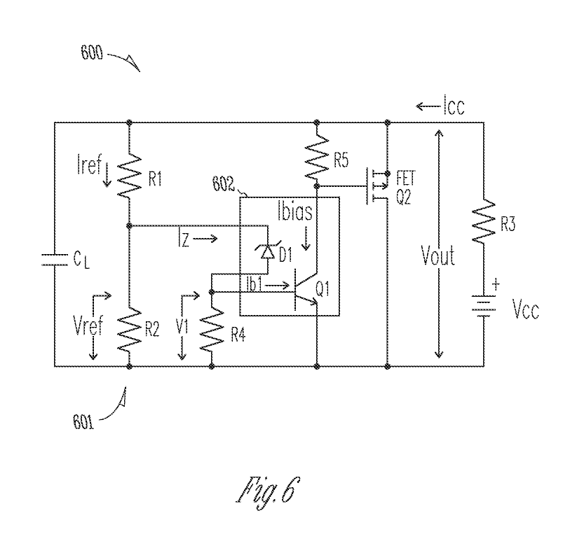

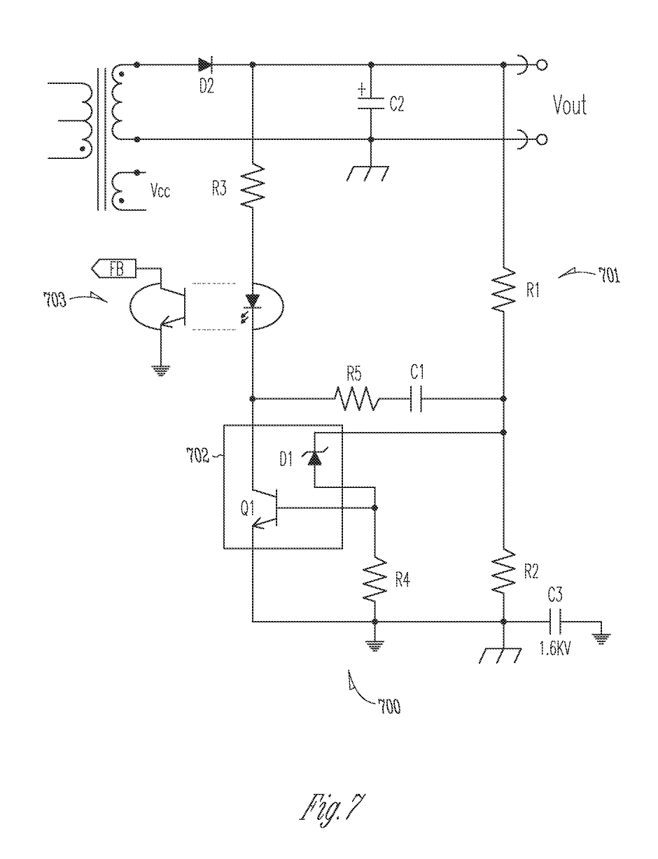

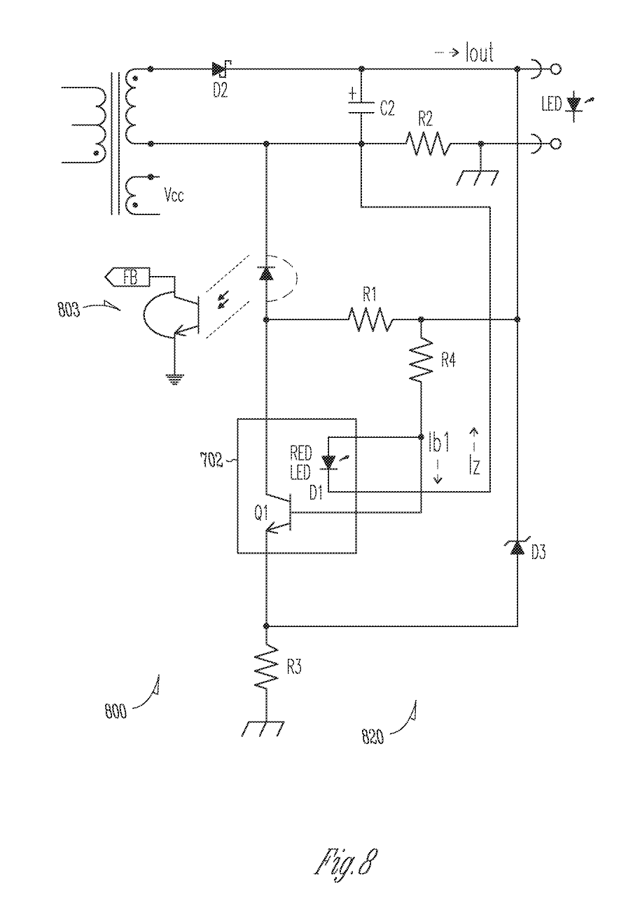

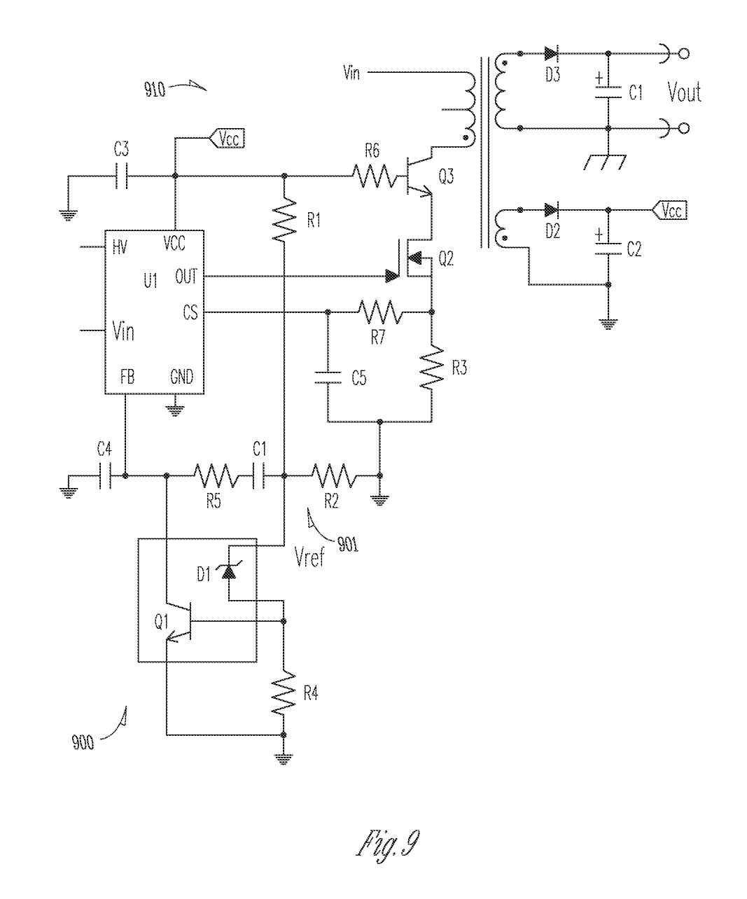

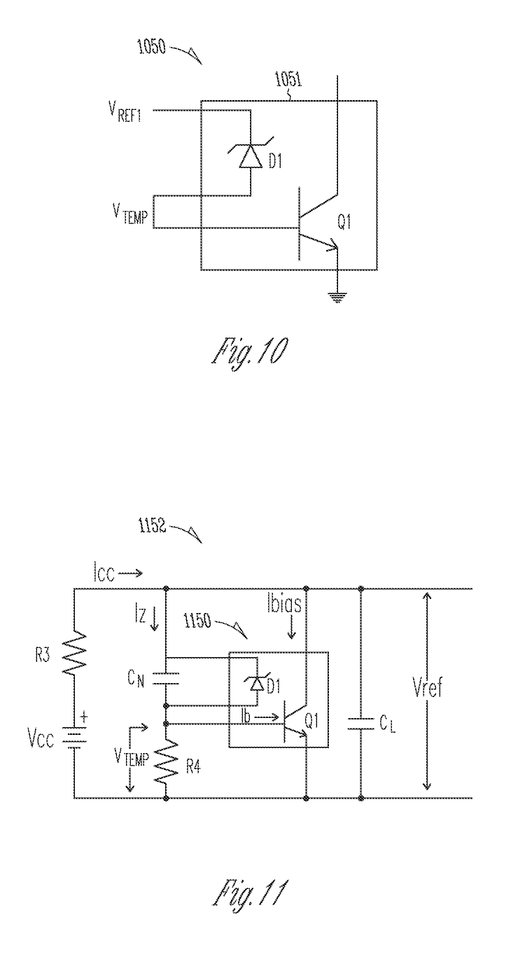

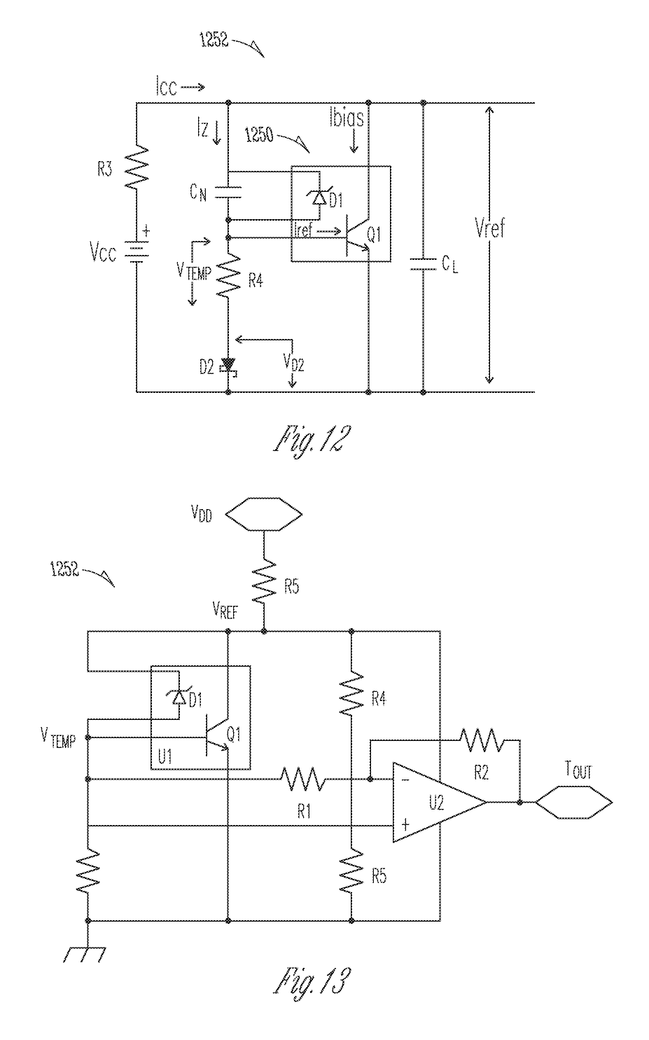

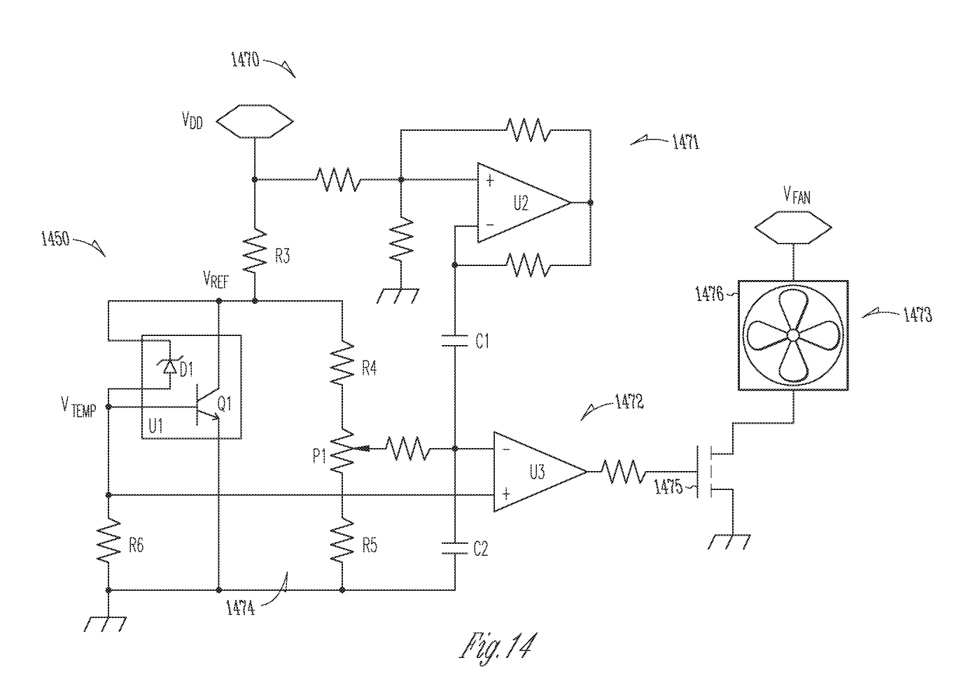

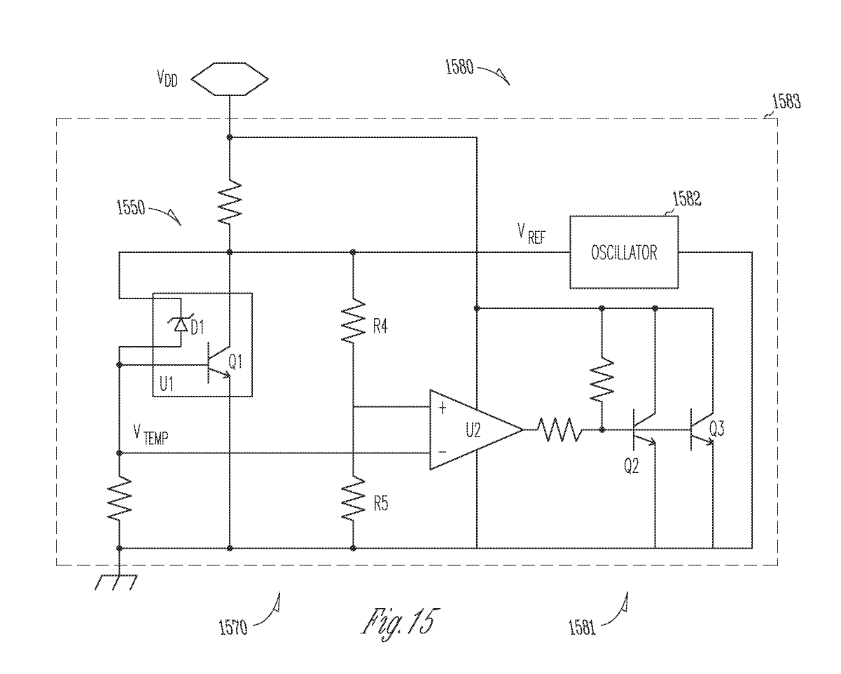

FIG. 5 illustrates an example low drop out (LDO) regulator 500 that can include a light emitting diode (LED) (D1) used as part of a voltage reference. Other low voltage references may also be used. The (LDO) regulator 500 can use p-channel metal-oxide-semiconductor-field-effect-transistor (MOSFET) (Q2) as a pass transistor to provide low drop out voltage and high output current capability. In applications requiring output voltages below about 3 volts, a PNP Darlington or high gain PNP transistor can be used. The use of the bipolar junction transistor (BJT) can require that higher bias currents be employed in the LDO regulator 500. The LED (D1) can provide good temperature compensation and low operating voltage at low bias levels resulting in high efficiency. In an example, the (LDO) regulator 500 can operate at a bias current of about 110 uA and can provide an output thermal stability of about −2.6 mV/C. In an example, at an output voltage of about 12 volts, the voltage across the LED (D1) can be about 1.46 volts, and the base emitter voltage of a regulator transistor (Q1) can be 0.487 volts. The reference voltage (V_{REF}) is the difference between these two values and can be about 0.973 volts. In this arrangement the transistor amplifies the difference between the voltage across the LED (D1) and the voltage at the emitter of the regulator transistor (Q1). The error gain is approximately the ratio of the collector impedance of the regulator transistor (Q1) to the emitter impedance of the regulator transistor (Q1).

In certain examples, instead of the thermal coefficients of the LED (D1) and the regulator transistor (Q1) complementing each other to provide thermal stability, the thermal constant variability of each device moves together as temperature changes such that the reference voltage (V_{REF}) remains substantially constant. The LED (D1) can provide a higher “on-voltage” than the base-emitter junction. The selection of the type of LED (D1) can include, but is not limited to, a red LED, infrared LED, ultra violet LED or other LED to provide an appropriate “on-voltage” for the application.

FIG. 6 illustrates generally an example high-power shunt regulator 600 including a regulator transistor (Q1), a diode (D1), a bias resistor (R4), a voltage divider 601 including a first resistor (R1) and a second resistor (R2), a pull-up resistor (R5), and a shunt transistor (Q2). The ground reference of the high-power shunt regulator 600 can allow the shunt transistor (Q2) to be driven using the full voltage range of an output voltage (V_{OUT}). The output voltage (V_{OUT}) can be set according to Eq. (3) where the reference voltage (V_{REF}) is the voltage across the diode (D1) plus the base-emitter junction of the regulator transistor (Q1). In an example, the high-power shunt regulator 600 can include an integrated circuit 602 including the regulator transistor (Q1) and the diode (D1).

FIG. 7 illustrates generally an isolated regulator 700 for the output of a switching power supply, such as can be found in a smart meter supply. The isolated regulator 700 can include an integrated circuit 702 including a regulator transistor (Q1), and a diode (D1). The isolated regulator 700 can include a bias resistor (R4), a voltage divider including a first resistor (R1) and a second resistor (R2), and an optical isolator 703. The optical isolator 703 can include an output configured to couple to a controller, such as a pulse-width controller of the power supply. The optical isolator 703 can be driven by the regulator transistor (Q1) in response to a current coupled to a control node of the regulator transistor (Q1) using the diode (D1). A reference voltage can be established across the diode (D1) and the base-emitter of the regulator transistor (Q1). In an example, the output voltage of the isolated regulator 700 can be set according to Eq. 3 where the reference voltage (V_{REF}) includes the reverse bias voltage of the diode (D1) and the voltage across the base-emitter junction of the regulator transistor (Q1) (e.g., a bipolar regulator transistor, etc.).

In certain examples, the standby bias current of the isolated regulator 700 is about 250 uA and the thermal stability of the isolated regulator 700 is about 50 ppm/C or less. In an example, the bias resistor (R4) can be used to bias the diode (D1) such that a thermal coefficient of the diode (D1) can compensate for a thermal coefficient of the regulator transistor (Q1), thus improving the overall stability of the isolated regulator 700.

FIG. 8 illustrates generally an example isolated power supply output current regulator 800 with overvoltage protection 820. Such an isolated power supply output current regulator 800 can be used to control current of a system load including, but not limited to, a motor driver load, lighting circuit load, such as an LED lighting circuit, or other system load that can benefit from voltage control or monitoring, or current control or monitoring. The isolated power supply output current regulator 800 can provide feedback to a controller (not shown), such as a pulse width controller, by using a sense voltage across a sense resistor (R2) to provide a representation of a load current. The sense voltage can be coupled to the regulator transistor (Q1) through a diode, such as a red LED (D1). As the impedance across the regulator transistor (Q1) responds to the sensed current, feedback generated via the collector of the regulator transistor (Q1) can be coupled to the controller. In an example, the isolated power supply output current regulator 800 can include an optical coupler 803 to electrically isolate the regulator feedback (FB) from the controller. If no load is coupled to the output of the isolated power supply output current regulator 800, the voltage at the output can increase to a very high voltage, such as a voltage capable of damaging one or more of the isolated power supply output current regulator 800 components.

In an example, the isolated power supply output current regulator 800 can include an overvoltage zener diode (D3) and a bias resistor (R3). As the voltage rises at the output of the isolated power supply output current regulator 800, the overvoltage zener diode (D3) can begin to shunt current through the bias resistor (R3) and stabilize the voltage at the output of the isolated power supply output current regulator 800 until a load is coupled to the output of the isolated power supply output current regulator 800.

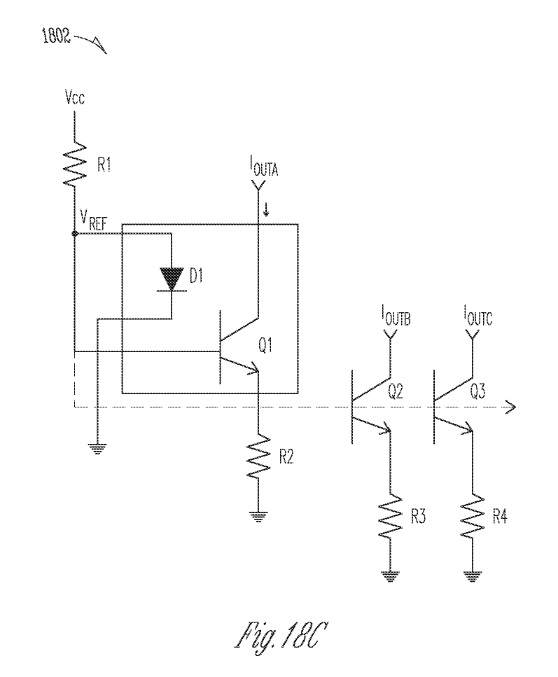

FIG. 17 illustrates generally an example isolated power supply output current regulator 1700 with overvoltage protection 1720. Such an isolated power supply output current regulator 1700 can be used to control or monitor a system load including, but not limited to, a motor driver load, lighting circuit load, such as an LED lighting circuit, or other system load that can benefit from voltage control or monitoring, or current control or monitoring. The isolated power supply output current regulator 1700 can provide feedback to a controller (not shown), such as a pulse width controller, by using a sense voltage across a sense resistor (R2) to provide a representation of a load current. The sense voltage can be coupled to the regulator transistor (Q1) via the emitter. As the impedance across the regulator transistor (Q1) responds to the sensed current, feedback generated via the collector of the regulator transistor (Q1) can be coupled to the controller. In certain examples, a Schottky diode (D1) can have similar thermal characteristics of the base-emitter of the regulator transistor, for example, a BJT, but the Schottky diode can have a much lower “on-voltage” than the base-emitter junction of the regulator transistor. Applying the sense voltage to the emitter can accommodate for the lower “on-voltage” of the Schottky diode (D1). A resistor (R1) can provide protection when the regulator turns on hard. The reference voltage for the current regulator can be the difference between the base-emitter voltage of the regulator transistor (Q1) and the forward voltage of the Schottky diode (D1) or around 0.25 volts at 25 C in certain examples.

In an example, the isolated power supply output current regulator 1700 can include an optical coupler 1703 to electrically isolate the regulator feedback (FB) from the controller. If an inadequate load is coupled to the output of the current output power supply, the voltage at the output can increase to a high voltage, such as a voltage capable of damaging circuits and components that are externally connected to the output of the power.

In an example, the isolated power supply output current regulator 1700 can include an overvoltage zener diode (D3). As the voltage rises above the breakdown voltage of the zener diode (D3) at the output of the isolated power supply, the overvoltage zener diode (D3) can begin to turn on the regulator transistor (Q1). As the regulator transistor (Q1) begins to conduct it can turn on the optical coupler 1703 to cause the PWM controller to reduce the drive pulse width and power delivered to the load causing the supply to regulate at the voltage set by diode D3 plus the emitter-base junction voltage of the regulator transistor (Q1).

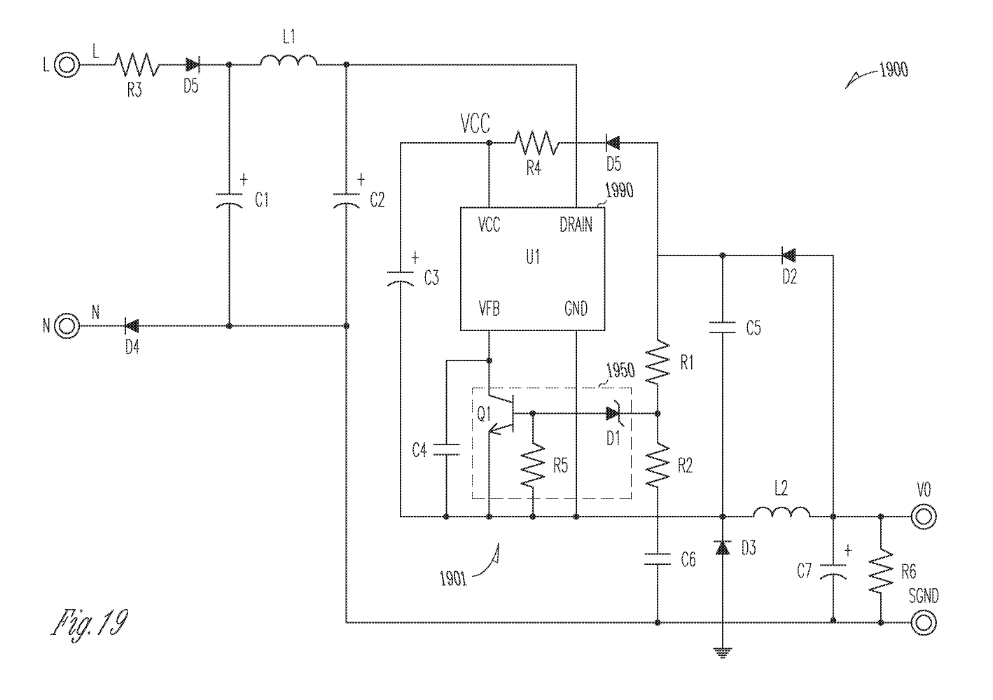

FIG. 18A, 18B, and 18C illustrate generally circuits including example current sources. Each example current source circuit can include an integrated circuit including a bipolar junction transistor (Q1) and an LED (D1). FIG. 18A illustrates generally an example current source 1800 circuit coupled to a supply voltage (Vcc) through a first resistor (R1) where the output current (lout) can be:

Iout=Vref/R2, where Vref can equal the forward voltage across the LED (D1) less the base-emitter voltage of the bipolar junction transistor (Q1).

FIG. 18B illustrates generally a high power current source 1801 coupled to a supply voltage (Vcc) through and first resistor (R1). The high power current source circuit 1801 can include the current source 1800 of FIG. 18A and a current amplifier. The current amplifier can include a second output transistor (Q2) and bias resistor (R3) to bias the second transistor (Q2) and to set the current through the bipolar junction transistor (Q1). It is understood that other types of second transistors (Q2) are possible in addition to the illustrated bipolar junction transistor shown in FIG. 18B without departing from the scope of the present subject matter. Types of transistors for the second transistor (Q2) can include, but are not limited to, Darlington transistors, FETs, MOSFETs, or combinations thereof.

FIG. 18C illustrates generally an example multiple current source circuit 1802. A first output current (Iouta) can equal Vref/R2. If R2=R3=R4, the multiple current source circuit 1802 can provide multiple sources of substantially equal current (Iouta, Ioutb, Ioutc). In certain examples, such a multiple current source circuit 1802 can be use to provide balanced current to strings of LEDs. In certain examples, additional current can be supplied using the current amplifier configuration of FIG. 18B.

FIG. 9 illustrates generally a power supply 910 including an example regulator 900 coupled to the primary side of the power supply transformer (T5), and thus can be referred to as a primary side regulator. The power supply 910 can include a controller (U1), first and second power transistors (Q2, Q3), a transformer (T5), and an example regulator 900. The controller (U1) can control the power transistor (Q3) to generate a voltage at the secondary of the transformer (T5). For example, when the controller (U1) provides a positive pulse to the gate of the power transistor (Q2), the power transistor (Q2) can turn on, and in turn, turn on a second power transistor (Q3). The voltage across the primary windings of the transformer (T5) can drop, thus inducing a voltage on the secondary winding of the transformer (T5). One or more diodes (D3) can rectify the voltage on the secondary of the transformer (T5) to provide an output voltage (V_{OUT}). The output voltage (V_{OUT}) and energy can be stored on a capacitor (C1). As the controller (U1) continues to drive the power transistor (Q3), the voltage on the capacitor (Cl) can increase. A secondary voltage (V_{CC}) used to power the primary side electronics can also be generated using the voltage induced on the secondary side of the power supply transformer (T5) using the principal that secondary voltage (V_{CC}) can provide a substantial representation of the output voltage (V_{OUT}), the controller (U1) and the regulator 900 can control the output voltage (V_{OUT}) using feedback derived from the secondary voltage (V_{CC}).

At about a desired secondary voltage (V_{CC}), a diode (D1) can couple a representation of the secondary voltage (V_{CC}) to the base of a regulator transistor (Q1) turning on the regulator transistor (Q1) and lowering the voltage at a feedback pin (FB) of the controller (U1). In response to the lower voltage at the feedback pin (FB), the controller (U1) can adjust, for example, a pulse width of a pulse to the power transistor (Q3), thus controlling the output voltage (V_{OUT}) to a predetermined level established by the relationship of the resistors (R1, R2) making up a voltage divider 901. A bias resistor (R4) can set a bias current of the diode (D1). In certain examples, the diode current can be set via the bias resistor (R4) to produce a thermal coefficient that closely matches and complements the emitter-base junction thermal coefficient of transistor (Q1).

In the illustrated example, the operating current of the example regulator 900 can be about 210 μA, the thermal coefficient of the regulator 900 can be about −42.9 ppm/C, and the reference voltage (V_{REF}) can be about 7.305 volts.

The regulator examples discussed above include a particular power supply topology. It is understood that the example regulators can be used with power supplies and voltage converters having other topologies without departing from the scope of the present subject matter. Such topologies can include but are not limited to inductor based buck and boost topologies. FIG. 19 illustrates generally a buck type voltage converter 1900 including an example regulator 1901. In certain examples, the regulator can include an integrated circuit 1950. The integrated circuit can include a BJT (Q1) and a diode, such as a zener diode (D1) to provide feedback to a buck controller 1990.

In addition to providing a building block for a regulator, a zener diode and bipolar junction transistor (BJT) can also provide, either alone or in combination, a building block for temperature sensing and precise voltage generation over a wide range of supply voltage and a wide range of temperature. There are many sensors available for temperature measurement including thermistors, thermocouples, and resistance temperature detectors (RTDs). Diode junctions can also be used to sense temperature due to change in the forward voltage of the junction with respect to temperature change. Diode junctions can have a nearly linear relationship between temperature and forward voltage change when bias current of the junction is constant. Diodes can be very economical for low cost applications compared to other temperature sensors.

Diode connected transistors, such as BJTs, can provide better accuracy than regular diodes, however, BJT current gain (hfe) can be a function of collector current and temperature and can affect temperature sensing accuracy. To minimize error caused by the current gain, biasing current variation over temperature can be minimized and a current source can be used to provide bias to avoid loading effects that can occur from voltage biasing. Although diode and BJT temperature sensors are not as accurate as other temperature sensors, such as thermocouples, they can provide sufficient accuracy which can make them useful in many low cost, low-precision applications such as turning on the fan in a laptop if the laptop gets too hot.

In certain examples, an integrated circuit can include a diode and a transistor. The integrated circuit can be used for temperature sensing, temperature-based control, stable, precision, reference voltage generation, or combinations thereof.

FIG. 10 illustrates generally an example temperature sensor 1050 that can also provide a stable reference voltage (V_{REF1}). The temperature sensor 1050 can include an integrated circuit 1051 that includes a zener diode (D1) and a bipolar-junction transistor (Q1). In an example, an anode of the zener diode (D1) can be coupled to the base of the BJT transistor (Q1). Establishing a voltage across the temperature sensor 1050 to allow current to flow through the zener diode (D1) and the collector and emitter nodes of the transistor (Q1) can allow the cathode of the zener diode (D1) to provide a stable reference voltage (V_{REF}), and can allow the base-emitter voltage (V_{TEMP}) of the transistor (Q1) to provide temperature information indicative of the temperature at or near the base-emitter junction of the transistor (Q1).

FIG. 11 illustrates generally a test circuit 1152 for providing analog voltage (V_{TEMP}) representative of temperature and a reference voltage (Vref). The test circuit 1152 includes an integrated circuit 1151 including a zener diode (D1) and a bipolar junction transistor (BJT) (Q1), an input for receiving a source voltage (V_{CC}), and first and second bias resistors (R3, R4).

A temperature sensor 1150 can include the base-emitter junction of the BJT (Q1). The base-emitter junction of the BJT (Q1) can have an inherent temperature coefficient such that the voltage across the base-emitter junction of the BJT (Q1) varies with temperature change for a given bias current setup (Icc, Iz). In an example, the temperature coefficient of a base-emitter junction of the BJT (Q1) in the test circuit 1152 can be about −2.1 millivolts per degree Celsius (mV/° C.). It is understood that other temperature coefficients are possible without departing from the scope of the present subject matter.

In certain examples, the voltage across the zener diode (D1) and the base-emitter junction of the BJT (Q1) can provide a very stable reference voltage (Vref) for powering other circuits or for providing a threshold voltage. In an example, with the following characteristics of the test circuit 1152:

Vcc=57.3 Volts;

Icc=1 milliamps (mA); and

Iz=60 microamps (μA),

the temperature error can be about 73 parts per million (ppm) from about −55° C. to about 150° C., and about 66 ppm from about −40° C. to about 125° C. For a 6.8 volt zener diode, the reference voltage can vary over the −50° C. to 150° C. temperature range about 0.1 volts from a minimum of about 7.34 volts at about −50° C. to a maximum of about 7.44 volts at about 84° C.

FIG. 12 illustrates generally a test circuit 1252 for measuring a temperature and a reference voltage. The test circuit 1252 includes an integrated circuit including a zener diode (D1) and a bipolar junction transistor (BJT) (Q1), a source voltage (V_{CC}), first and second bias resistors (R3, R4), and a temperature compensation diode (D2). The test circuit 1252 can provide improved performance over the test circuit of FIG. 11. Although the base-emitter junction of the BJT (Q1) can provide good temperature information over a wide temperature range, a portion of the temperature error can result from a change in the temperature coefficient of the base-emitter junction as the temperature changes. The temperature compensation diode (D2) can be selected to compensate for the current change in the second bias resistor (R4) due to the temperature variance of the base-emitter voltage. The second bias resistor (R4) can generally be used to set the bias current for the zener diode (D1) and directly influences the reverse voltage of the zener diode (D1) over temperature. For example, if the temperature coefficient of the base-emitter junction of the BJT (Q1) decreases with increasing temperature, a temperature compensation diode (D2) can be selected that has a temperature coefficient that decreases with increasing temperature resulting in a constant voltage across the second bias resistor (R4) which can result in a constant bias current through the diode (D1). Maintaining the constant bias current of the diode (D1) can result in more accurate temperature sensing and measurement over a wide temperature range, for example, a temperature range of about −55° C. to about 150° C. In certain examples, the second diode (D2) can include a Schottky diode. In an example, with the following characteristics of the test circuit 1252:

Vcc=57.3 Volts;

Icc=200 μA; and

Iz=40 μA,

the temperature error of a temperature sensor 1250 can be about 33 parts per million (ppm) from about −40° C. to about 125° C. For a 6.8 volt zener diode, the reference voltage can vary over the −50° C. to 150° C. temperature range about 0.08 volts from a minimum of about 7.35 volts at about −50° C. to a maximum of about 7.43 volts at about 84° C.

FIG. 13 illustrates generally an example temperature sensor circuit 1360 including a zener diode (D1), a BJT (Q1), and an amplifier (U2). In certain examples, an integrated circuit (U1) can include the diode (D1) and the BJT (Q1). The base-emitter junction of the BJT (Q1) can include a temperature coefficient, such that the voltage across the base-emitter junction of the BJT (Q1) can vary with temperature. An example temperature coefficient for the BJT (Q1) can be about −2.1 mV/° C. However, other temperature coefficients are possible without departing from the scope of the present subject matter. The amplifier (U2) can provide an output (T_{OUT}) that can be proportional to the temperature coefficient as well as eliminating bias offset of the BJT (Q1) or providing a desired offset. In an example, first and second gain resistors (R1, R2) can be selected to adjust the slope of the proportional output (T_{OUT}), and first and second offset resistors (R4, R5) can be selected to adjust an offset of the proportional output (T_{OUT}).

In certain examples, components of the temperature sensor circuit 1360 can be selected to operate using a supply voltage range from about 7.5 volts to about 100 volts. In certain examples, the temperature sensor circuit 1360 can provide robust temperature information over a temperature range of about −55° C. to about 150° C. In certain examples, an integrated circuit can include the diode (D1) and the BJT (Q1).

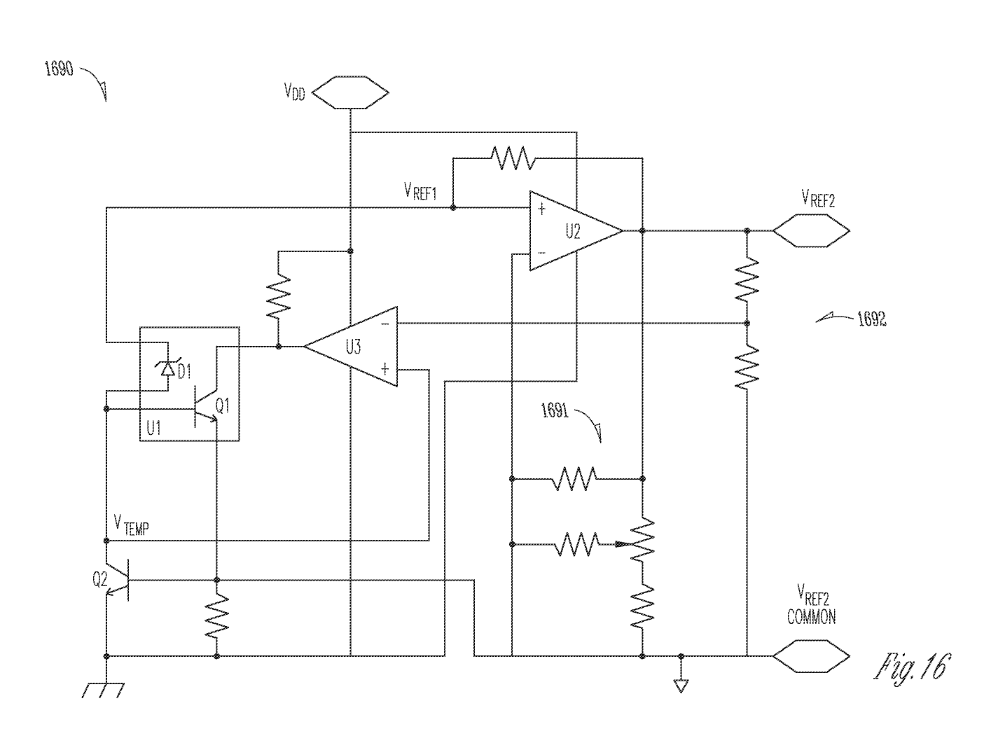

FIG. 14 illustrates generally an example temperature control system 1470. The temperature control system 1470 can include a temperature sensor 1450, a waveform generator, such as a sawtooth waveform generator 1471, and a pulse width modulator (PWM) 1472 configured to control the speed of a fan system 1473. In certain examples, the temperature sensor 1450 can include a BJT (Q1) and a diode (D1). In an example, temperature information provided by the base-emitter junction of the BJT (Q1) can be compared to a composite voltage of a sawtooth waveform and scaled reference voltage to provide a PWM speed signal to the fan system 1473.

In some examples, an operational amplifier (U2) can be used in a bi-stable configuration to charge and discharge one or more capacitors (C1, C2) to provide the sawtooth waveform which can be added to a scale reference voltage provided from a voltage divider 1474. The voltage divider 1474, for example, can include one or more resistors (R4, R5) and a potentiometer (P1), to provide an adjustable reference along with the sawtooth waveform. In such an example, the adjustable reference plus sawtooth waveform can provide a temperature set-point for the temperature control system 1470. In certain examples, the pulse width modulator 1472 can include a second operation amplifier (U3) that can compare the sawtooth waveform plus scaled reference voltage with the temperature information provided by the temperature sensor 1450 to provide a PWM command signal. A PWM command signal can control a power transistor 1475 to control the speed of a fan 1476. In certain examples, the fan 1476 can be used to control temperature, such as temperature of an enclosure, a room, an electrical circuit, an electronic device, a computer, etc. In an example, for a given sawtooth waveform and offset, and as the temperature increases, the voltage representative of temperature (V_{TEMP}) can decrease. At the second operational amplifier (U3), as the voltage at the non-inverting input decreases relative to the sawtooth waveform at the inverting input, a higher duty cycle, PWM command signal can be generated, thus causing the fan 1476 to run faster.

In certain examples, components of the temperature control system 1470 can be selected to operate using a supply voltage range from about 7.5 volts to about 100 volts. In certain examples, the temperature control system 1470 can provide robust temperature control over a temperature range of about −55° C. to about 150° C. In certain examples, an integrated circuit can include the diode (D1) and the BJT (Q1).

In some examples, the sawtooth waveform generator 1471 can be removed from the example shown in FIG. 14 to provide a less sophisticated on/off temperature control system. In such an example, the second amplifier (U3) can be configured to compare the temperature setpoint provided by the potentiometer (P1) with the temperature information provided by the temperature sensor 1450 to provide on/off temperature control using the fan 1476.

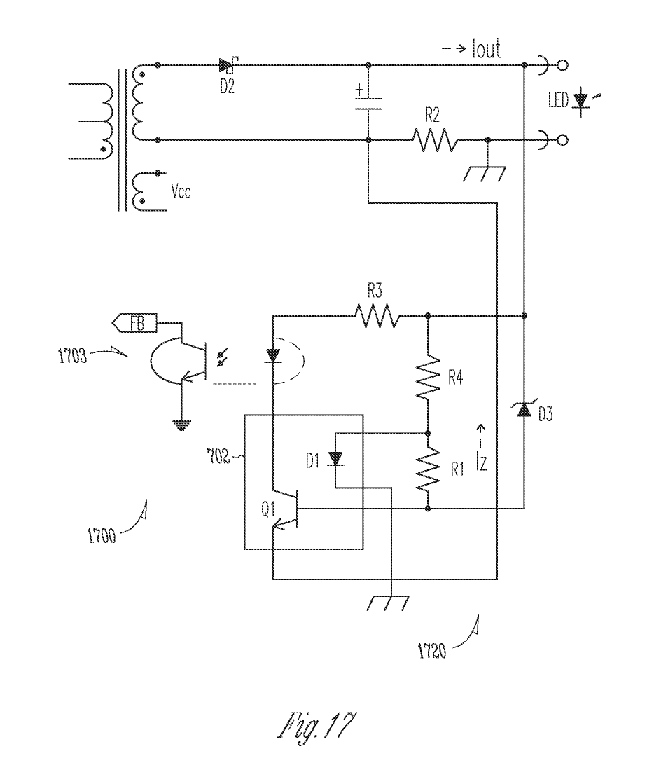

FIG. 15 illustrates generally an oscillator circuit 1580 including an example temperature control system 1570. In certain examples, the oscillator circuit 1580 can include a temperature sensor 1550, a heater system 1581, and an oscillator 1582. In an example, the temperature sensor 1550 can include a zener diode (D1) and a BJT (Q1). The base-emitter junction of the BJT (Q1) can provide temperature information. In certain examples, the zener diode (D1) can be configured to provide a stable reference voltage (V_{REF}). In some examples, an oscillator 1582 can receive the reference voltage (V_{REF}). In certain examples, stability of the oscillator 1582 can be influenced by the stability of the reference voltage (V_{REF}). The example temperature control system 1570 of FIG. 15 can provide a very stable reference voltage (V_{REF}), and thus a very stable oscillator 1582, by controlling the temperature of the oscillator circuit 1580. In certain examples, a voltage divider (R4, R5) coupled to the reference voltage (V_{REF}) can provide a temperature setpoint. In some examples, an amplifier (U2) can compare the temperature setpoint with temperature information to drive the heater system 1581. In an example, the heater system 1581 can be integrated with the temperature sensor 1550, the oscillator 1582, or both the temperature sensor 1550 and the oscillator 1582 to maintain a constant operating temperature of the oscillator circuit 1580. In certain examples, the heater system 1581 can include one or more transistors (Q2, Q3) configured to dissipate heat to maintain a stable operating temperature of the oscillator circuit 1580. It is understood that the temperature control system 1570 is not limited to controlling heaters and could include cooling elements or a combination of both heating and cooling elements.

In certain examples, the heating system can be located on a side of a printed circuit board (PCB) 1583 opposite the oscillator 1582 to maintain a stable local temperature of the oscillator 1582. In an example, components of the heater system 1581 can be coupled to the PCB 1583 using thermally conductive materials, such as copper, to dissipate heating or cooling influences more efficiently.

In certain examples, components of the oscillator circuit 1580 can be selected to operate using a supply voltage range from about 7.5 volts to about 100 volts. In certain examples, the oscillator circuit 1580 can provide robust performance over a temperature range of about −55° C. to about 150° C. In certain examples, an integrated circuit can include the diode (D1) and the BJT (Q1).

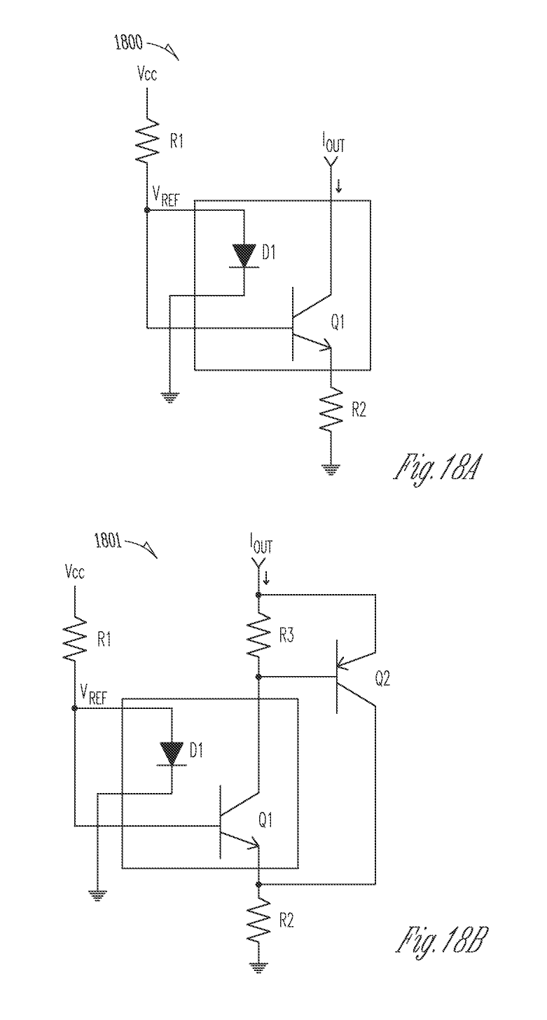

FIG. 16 illustrates generally an example temperature-stabilized, high-precision, voltage reference circuit 1690. The temperature-stabilized, high-precision, voltage reference circuit 1690 can provide a temperature-stabilized, high-precision, voltage reference (V_{REF2}) based on an internal voltage reference (V_{REF1}). The internal voltage reference (V_{REF1}) is designed to be stable using a zener diode (D1) summed with the base-emitter voltage of a BJT (Q1). The temperature stabilized aspect of the circuit can be provided by controlling the temperature of the zener diode (D1) using the BJT (Q1). In certain examples, temperature control of the zener diode (D1) can be accomplished by modulating a voltage and subsequent power dissipation across the BJT (Q1).

In certain examples, an output amplifier (U2) can receive the internal voltage reference (V_{REF1}) and can provide a buffered, scaled, temperature-stabilized, high-precision, voltage reference (V_{REF2}). In certain examples, resistors of a feedback network 1691 of the output amplifier (U2) can be selected to provide temperature-stabilized, high-precision, voltage reference (V_{REF2}) at a desired voltage level. In some examples, a resistor of the feedback network 1691 can be adjustable to provide a scaled, adjustable, temperature-stabilized, high-precision, voltage reference (V_{REF2}).

In certain examples, the BJT (Q1) can be configured to provide temperature information at or near the diode (D1) using the base-emitter junction of the BJT (Q1). A second feedback network 1692 coupled to the temperature-stabilized, high-precision, voltage reference (V_{REF2}) can provide temperature setpoint information. A temperature control amplifier (U3) can use the temperature information and the temperature setpoint information to modulate a voltage applied to the BJT (Q1). In certain examples, a bias transistor (Q2) can maintain a bias current through the BJT (Q1), such that by modulating the voltage applied to the BJT (Q1), temperature can be modulated using heat dissipated from the BJT (Q1). In some examples, the power of the heat dissipation can be estimated using the formula P=V*I, where P is power, I is the bias current through the BJT (Q1), and V is the voltage that can be modulated across the collector and emitter of the BJT (Q1).

In certain examples, components of the temperature-stabilized, high-precision, voltage reference circuit 1690 can be selected to operate using a supply voltage range from about 7.5 volts to about 100 volts. In certain examples, the temperature-stabilized, high-precision, voltage reference circuit 1690 can provide robust performance over a temperature range of about −55° C. to about 150° C. In certain examples, an integrated circuit can include the diode (D1) and the BJT (Q1).

### Additional Notes

In Example 1, an apparatus can include a diode having a first temperature coefficient, a bias resistor configured to bias the diode, a bipolar junction transistor having a second temperature coefficient, the bipolar junction transistor having a base coupled to the diode and the bias resistor, and wherein the first temperature coefficient and the second temperature coefficient are configured to reduce at least a portion of a temperature drift effect of the diode and the bipolar transistor.

In Example 2, the apparatus of Example 1 optionally includes a voltage divider including a first resistor and a second resistor, wherein a ratio of the first resistor and the second resistor is configured to establish an output voltage of the regulator.

In Example 3, the diode of any one or more of Examples 1-2 optionally includes an anode coupled to the base and a cathode coupled to the voltage divider.

In Example 4, the output voltage, VO, of any one or more of Examples 1-3 optionally is given by:

VO=VREF(1+R1/R2);

wherein VREF is a reference voltage, R1 is a resistance value of the first resistor, and R2 is a resistance value of the second resistor, and wherein the reference voltage includes a voltage across a base-emitter junction of the bipolar junction transistor and a voltage across the diode.

In Example 5, the diode of any one or more of Examples 1-4 optionally is configured to be forward biased to reduce the at least a portion of a temperature drift effect of the diode and the bipolar transistor.

In Example 6, the diode of any one or more Examples 1-5 optionally includes a light emitting diode (LED).

In Example 7, the diode of any one or more of Examples 1-6 optionally includes a cathode coupled to ground and an anode coupled to the base of the bipolar transistor.

In Example 8, the diode of any one or more of Examples 1-7 optionally is configured to be reversed biased to reduce the at least a portion of a temperature drift effect of the diode and the bipolar transistor.

In Example 9, the diode of any one or more of Examples 1-8 optionally includes a zener diode.

In Example 10, the apparatus of one or more if Examples 1-9 optionally includes a transistor coupled to a supply voltage, wherein the transistor is configured to control at least one of a base or a gate of the transistor to provide a regulated voltage.

In Example 11, the diode of any one or more of Examples 1-10 optionally includes a zener diode.

In Example 12, an apparatus can include a power transistor, a regulator, and a controller configured to control the power transistor and to receive feedback from a bipolar junction transistor of the regulator. The regulator can include a diode having a first temperature coefficient, a bias resistor configured to bias the diode, the bipolar junction transistor having a second temperature coefficient and having a base coupled to the diode and the bias resistor, and wherein the first temperature coefficient and the second temperature coefficient are configured to reduce at least a portion of a temperature drift effect of the diode and the bipolar transistor.

In Example 13, the regulator of any one or more of Examples 1-12 optionally includes a voltage divider including a first resistor and a second resistor, wherein a ratio of the first resistor and the second resistor is configured to establish an output voltage of the regulator.

In Example 14, the apparatus of any one or more of Examples 1-13 optionally includes an isolation element to couple the feedback from the bipolar transistor to the controller.

In Example 15, the isolation element of any one or more of Examples 1-14 optionally includes an optical isolator.

In Example 16, the diode of any one or more of Examples 1-15 optionally is configured to be forward biased to reduce the at least a portion of a temperature drift effect of the diode and the bipolar transistor.

In Example 17, the diode of any one or more of Examples 1-16 optionally includes a light emitting diode (LED).

In Example 18, the diode of any one or more of Examples 1-17 optionally includes a cathode coupled to ground and an anode coupled to the base of the bipolar transistor.

In Example 19, the diode of any one or more of Examples 1-18 optionally is configured to be reversed biased to reduce the at least a portion of a temperature drift effect of the diode and the bipolar transistor.

In Example 20, the diode of any one or more of Examples 1-19 optionally includes a zener diode.

In Example 21, the apparatus of any one or more of Examples 1-20 optionally includes a regulator.

In Example 22, a power supply can include a power supply controller, power electronics configured to receive an input voltage and to provide an output voltage using command signals from the power supply controller, and a regulator configured receive the output voltage and to provide feedback information to the power supply controller. The regulator can include a diode having a first temperature coefficient, a bias resistor configured to bias the diode, a bipolar junction transistor having a second temperature coefficient, the bipolar junction transistor having a gate coupled to the diode and the bias resistor, wherein the first temperature coefficient and the second temperature coefficient are configured to reduce at least a portion of a temperature drift effect of the diode and the bipolar transistor.

In Example 23, the regulator of any one or more of Examples 1-22 optionally includes a voltage divider including a first resistor and a second resistor, wherein a ratio of the first resistor and the second resistor configured to establish an output voltage of the regulator.

In Example 24, the diode of any one or more of Examples 1-23 optionally is configured to be forward biased to reduce the at least a portion of a temperature drift effect of the diode and the bipolar transistor.

In Example 25, the diode of any one or more of Examples 1-24 optionally includes a red, light emitting diode (LED).

In Example 26, the diode of any one or more of Examples 1-25 optionally is configured to be reversed biased to reduce the at least a portion of a temperature drift effect of the diode and the bipolar transistor.

In Example 27, the power electronics and the power supply controller of any one or more of Examples 1-26 optionally include a depletion mode transistor configured to receive the input voltage, wherein the bipolar junction transistor is configured to control a gate of the depletion mode transistor to provide the output voltage.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, although the examples above have been described relating to PNP devices, one or more examples can be applicable to NPN devices. In other examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus comprising:
a diode having a first temperature coefficient;
a bias resistor configured to bias the diode;
a bipolar junction transistor having a second temperature coefficient, the bipolar junction transistor having a base coupled to the diode and the bias resistor; and
wherein the first temperature coefficient and the second temperature coefficient are configured to reduce at least a portion of a temperature drift effect of the diode and the bipolar transistor.

2. The apparatus of claim 1, including a voltage divider including a first resistor and a second resistor, wherein a ratio of the first resistor and the second resistor is configured to establish an output voltage of the regulator.

3. The apparatus of claim 2, wherein the diode includes an anode coupled to the base and a cathode coupled to the voltage divider.

4. The regulator of claim 2, wherein the output voltage, V_{O}, is given by:
V_{O}=V_{REF}(1+R₁/R₂);
wherein V_{REF} is a reference voltage, R₁ is a resistance value of the first resistor, and R₂ is a resistance value of the second resistor; and
wherein the reference voltage includes a voltage across a base-emitter junction of the bipolar junction transistor and a voltage across the diode.

5. The apparatus of claim 1, wherein the diode is configured to be forward biased to reduce the at least a portion of a temperature drift effect of the diode and the bipolar transistor.

6. The apparatus of claim 5, wherein the diode includes a light emitting diode (LED).

7. The apparatus of claim 1, wherein the diode includes a cathode coupled to ground and an anode coupled to the base of the bipolar transistor.

8. The apparatus of claim 1, wherein the diode is configured to be reversed biased to reduce the at least a portion of a temperature drift effect of the diode and the bipolar transistor.

9. The apparatus of claim 8, wherein the diode includes a zener diode.

10. The apparatus of claim 1, including a transistor coupled to a supply voltage, wherein the transistor is configured to control at least one of a base or a gate of the transistor to provide a regulated voltage.

11. The apparatus of claim 10, wherein the diode includes a zener diode.

12. An apparatus comprising:
a power transistor;
a regulator including:
a diode having a first temperature coefficient;
a bias resistor configured to bias the diode;
a bipolar junction transistor having a second temperature coefficient, the bipolar junction transistor having a base coupled to the diode and the bias resistor; and
wherein the first temperature coefficient and the second temperature coefficient are configured to reduce at least a portion of
a temperature drift effect of the diode and the bipolar transistor; and
a controller configured to control the power transistor and to receive feedback from the bipolar junction transistor.

13. The apparatus of claim 12 wherein the regulator includes a voltage divider including a first resistor and a second resistor; and
wherein a ratio of the first resistor and the second resistor is configured to establish an output voltage of the regulator.

14. The apparatus of claim 12, including an isolation element to couple the feedback from the bipolar transistor to the controller.

15. The apparatus of claim 14, wherein the isolation element includes an optical isolator.

16. The apparatus of claim 12, wherein the diode is configured to be forward biased to reduce the at least a portion of a temperature drift effect of the diode and the bipolar transistor.

17. The apparatus of claim 16, wherein the diode includes a light emitting diode (LED).

18. The apparatus of claim 12, wherein the diode includes a cathode coupled to ground and an anode coupled to the base of the bipolar transistor.

19. The apparatus of claim 12, wherein the diode is configured to be reversed biased to reduce the at least a portion of a temperature drift effect of the diode and the bipolar transistor.

20. The apparatus of claim 19, wherein the diode includes a zener diode.
